(19) United States
(12) Patent Application Publication
(10) Pub. No.: US 2026/0255246 A1
(43) Pub. Date: Aug. 27, 2026

(54) SWITCHING METHODS, APPARATUS, DEVICE AND STORAGE MEDIUM

(71) Applicant: Beijing Xiaomi Mobile Software Co., Ltd., Beijing (CN)

(72) Inventor: Xingyi LUO, Beijing (CN)

(73) Assignee: Beijing Xiaomi Mobile Software Co., Ltd., Beijing (CN)

(21) Appl. No.: 18/995,365

(22) PCT Filed: Jul. 20, 2022
(86) PCT No.: PCT/CN2022/106884

§ 371 Date: Jan. 16, 2025

(51) Int. Cl. H04W 36/30

(52) U.S. Cl. CPC H04W 36/304

(57) ABSTRACT

The present disclosure relates to the field of mobile communications. Disclosed are switching methods, an apparatus, a device and a storage medium. A method comprises: a terminal performing switching to a target cell when determining that a beam measurement result of the target cell meets an evaluation condition. It is ensured that the terminal performs cell switching when determining that a beam measurement result meets an evaluation condition, so that the limitation that a network device is required to control the terminal to perform switching is broken through; the terminal automatically determines cell switching, so that a required switching duration is shortened, and the switching timeliness is improved.

### CROSS REFERENCE TO RELATED APPLICATIONS

This application is a US National Phase of a PCT Application No. PCT/CN2022/106884 filed on Jul. 20, 2022, the entire contents of which are incorporated herein by reference in their entireties.

### TECHNICAL FIELD

The present disclosure relates to the field of mobile communication, in particular to switching methods and apparatuses, devices, and storage media.

### BACKGROUND

In a mobile communication system, a network device covers at least one cell. When a terminal is within a range of a cell covered by the network device, the terminal can access the cell. When the terminal moves to another cell, cell handover is required. For example, the terminal measures a cell and reports a measurement result to the network device. The network device will return handover signaling to the terminal based on the measurement result, to instruct the terminal to perform handover.

However, since the network device controls the handover of the terminal, the required handover time is long, which has poor timeliness.

### SUMMARY

The embodiments of the present disclosure provide switching methods and apparatuses, devices, and storage media, which breaks the limitation of network devices only performing cell handover based on the cell measurement result and ensures the flexibility of cell switching for the terminal. The technical solution is as follows.

According to one aspect of the present disclosure, a switching method is provided. The method is performed by a terminal, and includes: in response to determining that a beam measurement result for a target cell meets an evaluation condition, switching to the target cell.

According to one aspect of the present disclosure, a switching method is provided. The method is performed by a first network device, and includes: transmitting configuration signaling to a terminal, where the configuration signaling is configured to configure an evaluation condition for the terminal. Where the evaluation condition is configured for the terminal to switch to a target cell when a beam measurement result for the target cell meets the evaluation condition.

According to one aspect of the present disclosure, a switching method is provided. The method is performed by the second network device, and includes: in response to a random access of a terminal, confirming that the terminal accesses a target cell corresponding to the second network device.

According to one aspect of the present disclosure, a switching apparatus is provided, and includes: a transmitting module, configured to transmit configuration signaling to a terminal, where the configuration signaling is configured to configure an evaluation condition for the terminal. Where the evaluation condition is configured for the terminal to switch to a target cell when a beam measurement result for the target cell meets the evaluation condition.

According to one aspect of the present disclosure, a switching apparatus is provided, and includes: a transmitting module, configured to transmit configuration signaling to a terminal, where the configuration signaling is configured to configure an evaluation condition for the terminal. Where the evaluation condition is configured for the terminal to switch to a target cell when a beam measurement result for the target cell meets the evaluation condition.

According to one aspect of the present disclosure, a switching apparatus is provided, and includes: a determining module, configured to, in response to a random access of a terminal, confirm that the terminal accesses a target cell corresponding to the second network device.

According to one aspect of the present disclosure, a terminal is provided, including: one or more processors; a transceiver connected to the one or more processors; and one or more memories configured to store executable instructions that can be executed by the one or more processors; where the one or more processors are configured to load and execute executable instructions to implement the switching method as described.

According to one aspect of the present disclosure, a network device is provided, including: one or more processors; a transceiver connected to the one or more processors; and one or more memories configured to store executable instructions that can be executed by the one or more processors; where the one or more processors are configured to load and execute executable instructions to implement the switching method as described.

According to one aspect of the present disclosure, a non-transitory computer-readable storage medium is provided, where the computer-readable storage medium stores executable program code, where one or more processors load and execute the executable program code to implement the switching method as described.

According to one aspect of the present disclosure, a chip is provided, including: programmable logic circuits and/or program instructions for implementing the switching method as described when the chip is run on a terminal or a network device.

According to one aspect of the present disclosure, a computer program product is provided for implementing the switching method of the aspects when the computer program product is executed by a processor of a terminal or a network device.

In the embodiments provided in the present disclosure, a scheme is provided for a terminal to determine whether to perform cell switching based on the beam measurement result, ensuring that the terminal performs cell switching when the beam measurement result meets the evaluation condition, which breaks the limitation of requiring the network device to control the terminal for switching, and allows the terminal to determine cell switching on its own, reducing the required switching time and improving the timeliness of switching.

### BRIEF DESCRIPTION OF DRAWINGS

In order to more clearly illustrate the technical solutions according to the embodiments of the present disclosure, drawings that need to be used in the description of the embodiments will be briefly introduced below. The drawings in the following description only relate to some embodiments of the present disclosure. For those skilled in the art, other drawings can also be obtained based on these drawings without creative effort.

FIG. 1 is a block diagram of a communication system according to an embodiment of the present disclosure.

FIG. 2 is a flowchart of a switching method according to an embodiment of the present disclosure.

FIG. 3 is a flowchart of a switching method according to an embodiment of the present disclosure.

FIG. 4 is a flowchart of an evaluation condition configuring method according to an embodiment of the present disclosure.

FIG. 5 is a flowchart of an evaluation condition configuring method according to an embodiment of the present disclosure.

FIG. 6 is a flowchart of a switching method according to an embodiment of the present disclosure.

FIG. 7 is a flowchart of a switching method according to an embodiment of the present disclosure.

FIG. 8 is a flowchart of a switching method according to an embodiment of the present disclosure.

FIG. 9 is a flowchart of a switching method according to an embodiment of the present disclosure.

FIG. 10 is a block diagram of a switching apparatus according to an embodiment of the present disclosure.

FIG. 11 is a block diagram of another switching apparatus according to an embodiment of the present disclosure.

FIG. 12 is a block diagram of a switching apparatus according to an embodiment of the present disclosure.

FIG. 13 is a block diagram of another switching apparatus according to an embodiment of the present disclosure.

FIG. 14 is a block diagram of a switching apparatus according to an embodiment of the present disclosure.

FIG. 15 is a block diagram of another switching apparatus according to an embodiment of the present disclosure.

FIG. 16 is a structural schematic diagram of a communication device according to an embodiment of the present disclosure.

### DETAILED DESCRIPTION

In clarify purposes, technical solutions, and advantages of the embodiments of the present disclosure, further detailed descriptions of the embodiments of the present disclosure are provided below in conjunction with the accompanying drawings.

Embodiments will be described in detail here with the examples thereof expressed in the drawings. Where the following description refers to the drawings, elements with the same numerals in different drawings refer to the same or similar elements unless otherwise indicated. Embodiments described in the illustrative examples below are not intended to represent all embodiments consistent with the present disclosure. Rather, they are merely embodiments of devices and methods consistent with some aspects of the present disclosure as recited in the appended claims.

Terms used in the present disclosure is only for the purpose of describing particular embodiments and is not intended to limit the present disclosure. As used in the present disclosure and claims, the singular forms “a”, “said”, and “the” are intended to include the plural forms as well, unless the context clearly indicates otherwise. It should further be understood that the term “and/or” as used herein refers to and includes any and all possible combinations of one or more of the associated listed items.

It shall be understood that, although the terms “first,” “second,” “third,” and the like may be used herein to describe various information, the information should not be limited by these terms. These terms are only used to distinguish the same type of information from each other. For example, without departing from the scope of the present disclosure, first information may be referred as second information; and similarly, second information may also be referred as first information. Depending on the context, the word “if” as used herein can be interpreted as “at the time of”, “when” or “in response to determining”.

It should be noted that information (including but not limited to user equipment information, user personal information, etc.), data (including but not limited to data used for analysis, stored data, displayed data, etc.), and signals involved in the present disclosure are all authorized by users or fully authorized by all parties, and the collection, use, and processing of relevant data comply with relevant laws, regulations, and standards of relevant countries and regions.

An application scenario of the present disclosure is explained.

FIG. 1 is a block diagram of a communication system according to an embodiment of the present disclosure. The communication system may include a terminal 10 and network devices 20.

There are usually multiple terminals 10, and one or more terminals 10 can be distributed within a cell (shown with the dashed-line ovals) managed by each network device 20. The terminal 10 may include various handheld devices, in vehicle devices, wearable devices, computing devices, or other processing devices connected to wireless modems with wireless communication capabilities, as well as various forms of user equipment (UE), mobile stations (MS), and so on. For the convenience of description, in the embodiments of the present disclosure, the devices mentioned are collectively referred to as terminals.

The network device 20 is a device deployed in the access network to provide wireless communication functionality for the terminal 10. For the convenience of description in the embodiments of the present disclosure, the devices that provide wireless communication functionality for the terminal 10 are collectively referred to as network devices. The network device 20 and the terminal 10 can establish a connection through an air interface for communication, including exchange of signaling and data. There can be multiple network devices 20, and communication between two adjacent network devices 20 can also be conducted through wired or wireless means. A terminal 10 can switch (e.g., handover) between different network devices 20, i.e., establish connections with different network devices 20.

The network device 20 can include various forms of macro base stations, micro base stations, relay stations, access points, and so on. In systems using different wireless access technologies, the names of devices with network device functions may vary, such as gNodeB or gNB in 5G NR (New Radio) systems. With the evolution of communication technology, the name “network device” may change.

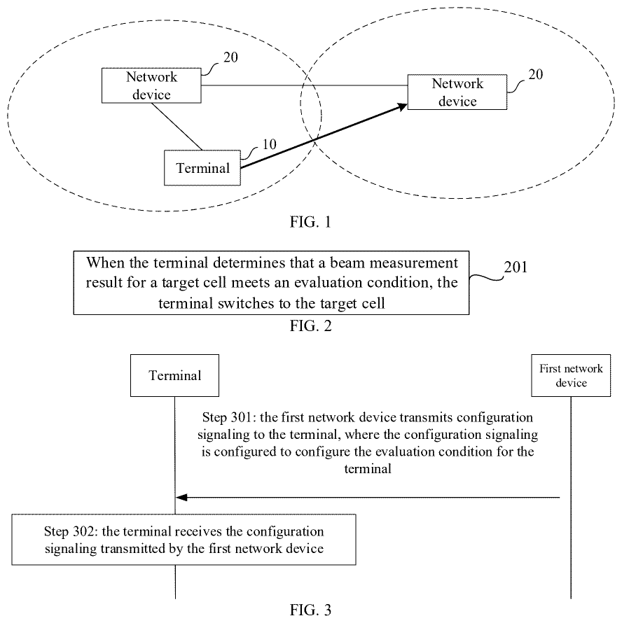

FIG. 2 is a flowchart of a switching method according to an embodiment of the present disclosure, which can be applied to the terminal shown in FIG. 1. The method includes at least some of the following contents.

In step 201, when the terminal determines that a beam measurement result for a target cell meets an evaluation condition, the terminal switches (e.g., handovers) to the target cell.

The beam measurement result refers to the result obtained by the terminal through L1 (layer 1) measurement.

The evaluation condition refers to a judgment condition for performing cell switching for the terminal. When the terminal determines that the beam measurement result for a candidate cell meets the evaluation condition, the terminal can switch to the candidate cell that meets the evaluation condition.

In the embodiments of the present disclosure, the beam measurement result includes the measurement result obtained by the terminal performing measurement on at least one candidate cell. That is, the terminal measures at least one candidate cell, to obtain the beam measurement result for the at least one candidate cell. Subsequently, the terminal can determine whether to switch to the target cell based on the beam measurement result.

The candidate cell refers to a cell that the terminal can perform beam measurement on and may be accessed by the terminal as the target cell. In some embodiments, at least one candidate cell is configured by a network device.

In some embodiments, the target cell is a cell meeting the evaluation condition that is determined by the terminal based on the beam measurement result for the at least one candidate cell.

In some embodiments, the target cell is a cell that meets the evaluation condition. When there is a candidate cell whose beam measurement result meets the evaluation condition in the at least one candidate cell, the candidate cell that meets the evaluation condition is determined as the target cell.

In some embodiments, the target cell is determined from a plurality of candidate cells that meet the evaluation condition. When there are a plurality of candidate cells, if beam measurement results for multiple candidate cells in the plurality of candidate cells meet the evaluation condition, the user selects one candidate cell from the multiple candidate cells that meet the evaluation condition as the target cell.

In some embodiments, the terminal measures at least one candidate cell to obtain the beam measurement result of each candidate cell, and subsequently determines whether the evaluation condition is met based on the beam measurement result for the candidate cell.

It should be noted that in the embodiment of the present disclosure, it is illustrated using the example of performing the candidate cell measurement once. In another embodiment, the terminal can measure the at least one candidate cell multiple times. That is, the terminal can perform step 201 multiple times and dynamically switch cells.

In some embodiments, the terminal performs beam measurement every preset duration, and then determines whether the evaluation condition is met for switching based on the beam measurement result, i.e., dynamic switching is achieved.

For example, the preset duration is set by the network device, agreed upon by the communication protocol, or set in other ways, which is not limited in the embodiments of the present disclosure.

In the embodiments provided in the present disclosure, a scheme is provided for a terminal to determine whether to perform cell switching based on the beam measurement result, ensuring that the terminal immediately performs cell switching when the beam measurement result meets the evaluation condition, which breaks the limitation of requiring the network device to control the terminal for switching, and allows the terminal to determine cell switching on its own, reducing the required switching time and improving the timeliness of switching.

FIG. 2 illustrates that the terminal can determine to switch to the target cell based on the evaluation condition. In other embodiments, the network device needs to first configure the evaluation condition for the terminal, and then the terminal can determine to switch to the target cell based on the evaluation condition. FIG. 3 is a flowchart of a switching method according to an embodiment of the present disclosure, which can be applied to the terminal and the network devices shown in FIG. 1. The method includes at least some of the following contents.

In step 301, the first network device transmits configuration signaling to the terminal, where the configuration signaling is configured to configure the evaluation condition for the terminal.

In some embodiments, the first network device corresponds to the source cell and can also be the source cell.

In step 302, the terminal receives the configuration signaling transmitted by the first network device.

In the embodiments of the present disclosure, after the network device determines the evaluation condition, the network device can transmit configuration signaling to the terminal for configuring the evaluation condition. After receiving the configuration signaling, the terminal can determine the evaluation condition indicated by the configuration signaling. Subsequently, the terminal switches to the target cell when it is determined that the beam measurement result for the target cell meets the evaluation condition.

In some embodiments, the configuration signaling includes an event identification, where the event identification indicates the event corresponding to the evaluation condition.

In the embodiments of the present disclosure, the first network device configures an event corresponding to the evaluation condition for the terminal through configuration signaling, and the terminal determines whether the candidate cell meets the evaluation condition based on whether the event occurs.

For example, event identification 1 indicates event 1, and event identification 2 indicates event 2. Alternatively, event identification can be other identification to indicate other events, which is not limited in the embodiments of the present disclosure.

In some embodiments, the event configured by the configuration signaling is an L1 event, and the first network device can configure the evaluation condition for the terminal through the configuration signaling.

In some embodiments, the L1 event includes at least one of the following.
(1) Event 1, where Event 1 is the measurement result of the best beam for a candidate cell being greater than the sum of the measurement result of the best beam for the serving cell and the first offset value (offset 1).
(2) Event 2, where Event 2 is the average value of the beam measurement result for a candidate cell being greater than the sum of the average value of the beam measurement result for the serving cell and the second offset value (offset 2).
(3) Event 3, where Event 3 is the average or maximum value of the beam measurement result for the candidate cell being greater than the preset threshold.
(4) Event 4, where Event 4 is the top N best measurement results being the measurement results for candidate cells, where N is a positive integer.

It should be noted that the embodiments of the present disclosure are illustrated using the four events as examples, and the embodiments of the present disclosure may also include other events, which is not limited by the embodiments of the present disclosure.

In some embodiments, the configuration signaling is RRC (Radio Resource Control) signaling or other types of signaling, which is not limited by the embodiments of the present disclosure.

In the solution provided by the embodiments of the present disclosure, the first network device configures the evaluation condition for the terminal through configuration signaling, such that the terminal can perform cell switching based on the configured evaluation condition, which breaks the limitation of requiring the network device to control the terminal for switching. The terminal can determine the cell switching itself, which reduces the required switching time and improves the timeliness of switching.

It should be noted that there are various ways for the first network device to configure the evaluation condition for the terminal in the present disclosure. The evaluation condition configured by the first network device will be explained below.

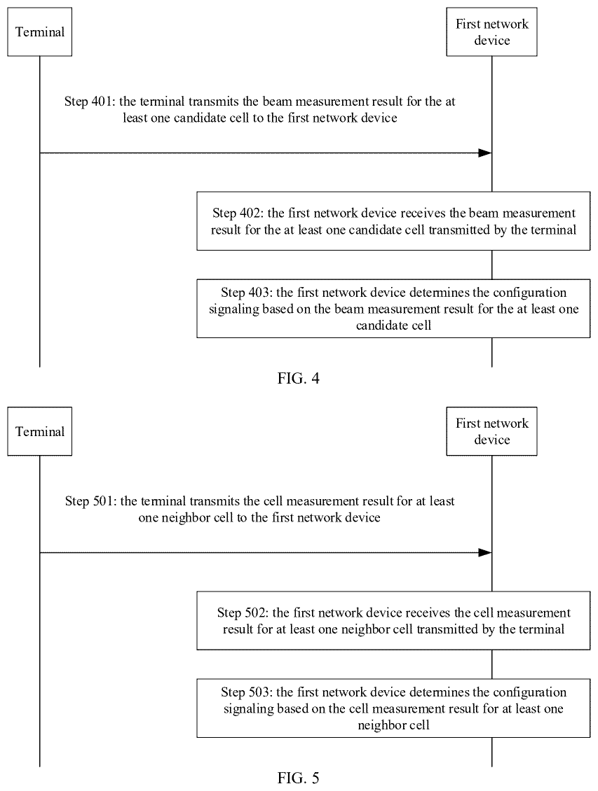

The first method: the first network device configures the evaluation condition for the terminal based on the beam measurement result. FIG. 4 is a flowchart of an evaluation condition configuring method according to an embodiment of the present disclosure, which can be performed by a terminal and a network device as shown in FIG. 1. The method includes at least some of the following contents.

In step 401, the terminal transmits the beam measurement result for the at least one candidate cell to the first network device.

In step 402, the first network device receives the beam measurement result for the at least one candidate cell transmitted by the terminal.

In step 403, the first network device determines the configuration signaling based on the beam measurement result for the at least one candidate cell.

In the embodiments of the present disclosure, the terminal performs beam measurement on the at least one candidate cell to obtain the beam measurement result, and then transmits the measured beam measurement result to the first network device. After receiving the beam measurement result for the at least one candidate cell, the first network device can determine the configuration signaling based on the received beam measurement result, and then configure the evaluation condition for the terminal. Subsequently, the terminal can determine whether the (beam) measurement result of at least one candidate cell meets the evaluation condition based on the configured evaluation condition.

In some embodiments, the terminal performs beam measurement on at least one candidate cell, and after obtaining the beam measurement result, the terminal will report the beam measurement results of some candidate cells to the first network device, and will not transmit all the obtained beam measurement results to the first network device.

In some embodiments, at least one candidate cell is configured by the first network device, or configured in other ways, which is not limited in the embodiments of the present disclosure.

In the solution provided by the embodiments of the present disclosure, the first network device can determine the configuration signaling based on the beam measurement result for the at least one candidate cell, and then configure the evaluation conditions for the terminal, such that the terminal can perform cell switching based on the configured evaluation condition, which breaks the limitation of requiring the network device to control the terminal for switching. The terminal can determine the cell switching itself, which reduces the required switching time and improves the timeliness of switching.

The second method: the first network device configures the evaluation condition for the terminal based on the measurement results of neighbor cells. FIG. 5 is a flowchart of an evaluation condition configuring method according to an embodiment of the present disclosure, which can be performed by a terminal and a network device as shown in FIG. 1. The method includes at least some of the following contents.

In step 501, the terminal transmits the cell measurement result for at least one neighbor cell to the first network device.

Where the configuration signaling is determined by the first network device based on the cell measurement result for the at least one neighbor cell and transmitted by the first network device.

The cell measurement result refers to the result obtained by the terminal through L3 (layer 3) measurement.

In step 502, the first network device receives the cell measurement result for at least one neighbor cell transmitted by the terminal.

In step 503, the first network device determines the configuration signaling based on the cell measurement result for at least one neighbor cell.

In the embodiments of the present disclosure, the terminal performs cell measurement on at least one neighbor cell to obtain the cell measurement result, and then transmits the measured cell measurement result to the first network device. After receiving the cell measurement result for at least one neighbor cell, the first network device can determine the configuration signaling based on the received cell measurement result, and then configure the evaluation condition for the terminal. Subsequently, the terminal can determine whether at least one candidate cell meets the evaluation conditions based on the configured evaluation condition.

In some embodiments, at least one neighbor cell is configured by the first network device, or configured in other ways, which is not limited in the embodiments of the present disclosure.

In the solution provided by the embodiments of the present disclosure, the first network device can determine the configuration signaling based on the beam measurement result for the at least one neighbor cell, and then configure the evaluation conditions for the terminal, such that the terminal can perform cell switching based on the configured evaluation condition, which breaks the limitation of requiring the network device to control the terminal for switching. The terminal can determine the cell switching itself, which reduces the required switching time and improves the timeliness of switching.

In some embodiments, the configuration signaling is further configured to configure at least one candidate cell for the terminal, where the at least one candidate cell is a cell for determining whether the evaluation condition is met, and the at least one candidate cell is determined by the first network device based on the cell measurement result for the at least one neighbor cell.

Where at least one candidate cell is determined by the first network device based on the cell measurement result for at least one neighbor cell. That is, when it is determined that the cell measurement result for the neighbor cell meets the configuration condition, the neighbor cell corresponding to the cell measurement result that meet the configuration condition can be determined as the candidate cell.

In some embodiments, in the case where the cell measurement result for a neighbor cell is greater than the preset measurement result, it is determined that the cell measurement result for the neighbor cell meets the configuration condition.

In some embodiments, if it is determined that the cell measurement result for the neighbor cell is greater than the sum of the cell measurement result of the serving cell and the third offset value (offset 3), it is determined that the cell measurement result for the neighbor cell meet the configuration condition.

It should be noted that after receiving the configuration signaling, the terminal can determine at least one candidate cell configured by the configuration signaling. The terminal can then perform beam measurement on the at least one candidate cell indicated by the configuration signaling, determine whether the evaluation condition is met based on the obtained beam measurement result, and ultimately switch to the target cell that meets the evaluation condition.

In some embodiments, after receiving the configuration signaling transmitted by the first network device, the terminal will not perform beam measurement on all candidate cells configured by the configuration signaling, but can perform beam measurements on some of the candidate cells configured by the configuration signaling, and then determine whether the evaluation condition is met based on the beam measurement results of some of the candidate cells.

Where the terminal receives indication signaling transmitted by the first network device. The indication signaling indicates at least one to-be-evaluated cell. At least one to-be-evaluated cell belongs to at least one candidate cell, and the number of to-be-evaluated cells is less than the number of candidate cells. The at least one to-be-evaluated cell is a cell for which the terminal currently determines whether the evaluation condition is met.

In the embodiments of the present disclosure, the first network device transmits indication signaling to the terminal, and through the indication signaling, some of the at least one of the candidate cells can be activated, and the activated cells are the to-be-evaluated cells. Alternatively, some of the at least one candidate cell can be activated through the indication signaling, and the cells other than the activated cells in the at least one candidate cell are the to-be-evaluated cells. Alternatively, by the indication signaling, some of the at least one candidate cell can be selected, and the selected cells are the to-be-evaluated cells.

In the embodiments of the present disclosure, at least one to-be-evaluated cell is indicated through the indication signaling, and the terminal can perform beam measurement on the at least one to-be-evaluated cell to obtain the beam measurement result without measuring all candidate cells, which can save terminal energy consumption.

The embodiment shown in FIG. 2 is an example of the terminal being able to switch to a cell on its own. The following will explain how the terminal switches to the target cell.

In some embodiments, the terminal accesses the target cell indicated by the handover signaling through random access. For the second network device corresponding to the target cell, the second network device responds to the random access from the terminal and confirms the access of the terminal to the target cell of the second network device.

The random access refers to that the terminal transmits a random access preamble to the second network device corresponding to the target cell, the second network device receives the random access preamble and transmits a random access response in response to the random access preamble, the terminal receives the random access response and transmits an RRC connection request, and the second network device receives the RRC connection request and completes the access.

That is, in the embodiments of the present disclosure, the terminal can switch to the target cell through the random access when determining that the target cell meets the evaluation condition.

In some embodiments, the resources used for random access are configured by configuration signaling. The resources used for random access refer to the resources used for transmitting information during the random access.

In the solution provided in this embodiment of the present disclosure, the terminal switches to the target cell through random access signaling, which breaks the limitation of requiring the network device to control the terminal for switching. The terminal can determine the cell switching itself, which reduces the required switching time and improves the timeliness of switching.

It should be noted that the embodiment is based on the example of a terminal switching to a target cell through random access. In another embodiment, when the terminal has obtained TA (Timing Advance), the terminal can directly switch to the target cell.

In the embodiments of the present disclosure, when the terminal has obtained TA, the terminal transmits access confirmation information to the second network device corresponding to the target cell based on the configured resources and switches to the target cell. For the second network device corresponding to the target cell, the second network device receives the access confirmation information transmitted by the terminal and confirms that the terminal accesses the target cell.

In the embodiments of the present disclosure, the TA indicates the timing advance of the terminal, that is, the terminal can complete uplink synchronization according to the TA. Therefore, the terminal can transmit access confirmation information to the second network device corresponding to the target cell based on the configured resources, and inform the second network device through the access confirmation information that the terminal accesses the target cell, and then communicate through the target cell.

Where the access confirmation information indicates that the terminal has accessed the target cell.

In some embodiments, the resource used to transmit access confirmation information to the target cell is PUSCH (Physical Uplink Shared Channel) resource. For example, the terminal transmits a MAC CE (Media Access Control Control Element) to the target cell through a PUSCH resource to indicate successful access to the target cell.

In other embodiments, the resource used to transmit access confirmation information to the target cell is SR (Scheduling Request) resource. For example, the terminal transmits SR to the target cell through an SR resource to indicate successful access to the target cell. For example, the terminal transmits a scheduling request to the target cell through an SR resource, where the scheduling request is used to schedule PUSCH. The terminal then transmits a configuration complete message based on the scheduled PUSCH, where the configuration complete message indicates confirmation of access to the target cell.

In the solution provided in the embodiments of the present disclosure, when the terminal has obtained TA, the terminal can switch to the target cell by transmitting access confirmation information, which breaks the limitation of requiring the network device to control the terminal for switching. The terminal can determine the cell switching itself, which reduces the required switching time and improves the timeliness of switching.

It should be noted that in the present disclosure, after the second network device confirms the access of the terminal, the second network device further transmits success information to the CU, where the success information indicates that the terminal has successfully accessed the target cell.

In the embodiments of the present disclosure, the CU (Central Unit) belongs to a unit in gNB. In some embodiments, the original gNB concept is split into one CU and multiple DUs (Distributed Units), where the CU is a central unit used to control multiple DUs. The embodiments of the present disclosure are not limited to the splitting form, and there may also be different forms of splitting.

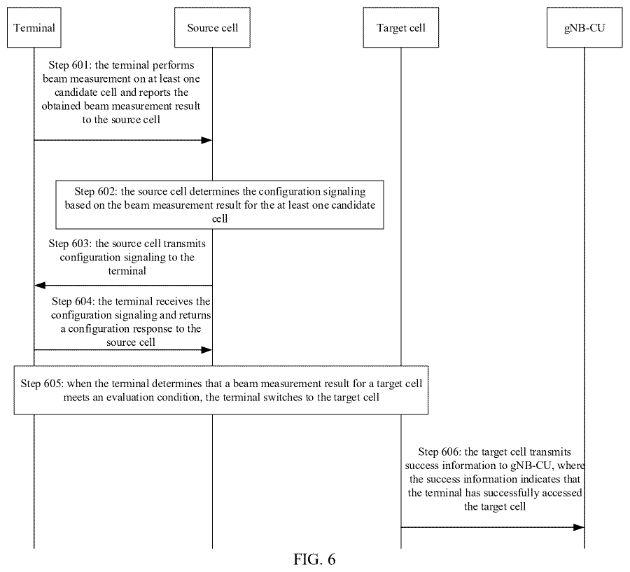

Below, examples will be provided to illustrate the embodiments. Taking the cell configured by the first network device as the source cell, the cell configured by the second network device as the target cell, and the CU as gNB-CU as an example, the evaluation condition configured by the source cell based on the beam measurement result is explained. Referring to FIG. 6, FIG. 6 is a flowchart of a switching method according to an embodiment of the present disclosure, which includes at least some of the following contents.

In step 601, the terminal performs beam measurement on at least one candidate cell and reports the obtained beam measurement result to the source cell.

In step 602, the source cell determines the configuration signaling based on the beam measurement result for the at least one candidate cell.

In step 603, the source cell transmits configuration signaling to the terminal.

In step 604, the terminal receives the configuration signaling and returns a configuration response to the source cell.

It should be noted that step 604 is illustrated using the example of the terminal returning a configuration response to the source cell. In another embodiment, the terminal can also return a configuration response to the target cell.

In step 605, when the terminal determines that a beam measurement result for a target cell meets an evaluation condition, the terminal switches to the target cell.

In step 606, the target cell transmits success information to gNB-CU, where the success information indicates that the terminal has successfully accessed the target cell.

It should be noted that in the embodiments of the present disclosure, the steps performed by the terminal can form a new embodiment separately, and the steps performed by the network device can also form a new embodiment separately, which is not limited in the embodiments of the present disclosure.

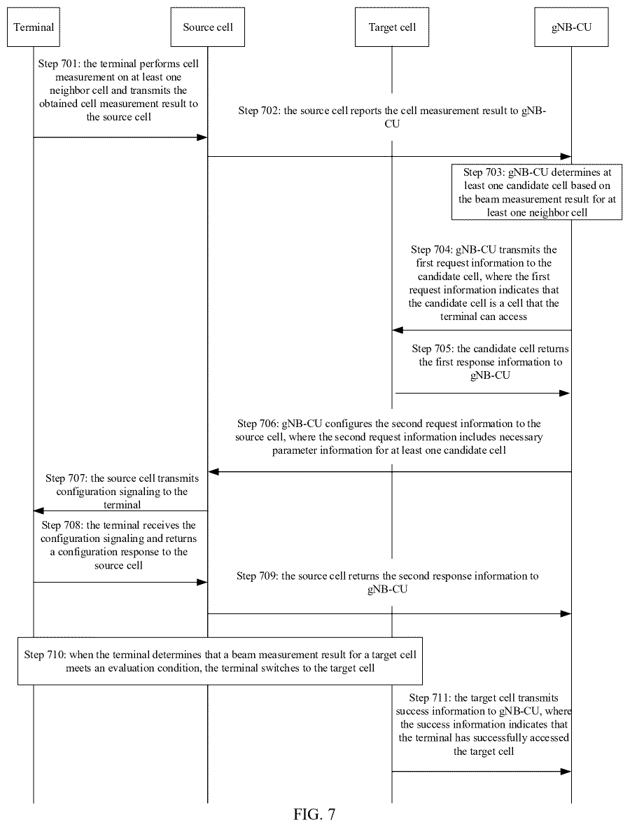

Examples are provided to illustrate the included embodiments. Taking the cell configured by the first network device as the source cell, the cell configured by the second network device as the target cell, and the CU as gNB-CU as an example, the evaluation condition configured by the source cell based on the beam measurement result is explained. Referring to FIG. 7, FIG. 7 is a flowchart of a switching method according to an embodiment of the present disclosure, which includes at least some of the following contents.

In step 701, the terminal performs cell measurement on at least one neighbor cell and transmits the obtained cell measurement result to the source cell.

In step 702, the source cell reports the cell measurement result to gNB-CU.

In step 703, gNB-CU determines at least one candidate cell based on the beam measurement result for at least one neighbor cell.

In step 704, gNB-CU transmits the first request information to the candidate cell, where the first request information indicates that the candidate cell is a cell that the terminal can access.

In step 705, the candidate cell returns the first response information to gNB-CU.

In step 706, gNB-CU configures the second request information to the source cell, where the second request information includes necessary parameter information for at least one candidate cell.

In step 707, the source cell transmits configuration signaling to the terminal.

In step 708, the terminal receives the configuration signaling and returns a configuration response to the source cell.

In step 709, the source cell returns the second response information to gNB-CU.

In step 710, when the terminal determines that a beam measurement result for a target cell meets an evaluation condition, the terminal switches to the target cell.

In step 711, the target cell transmits success information to gNB-CU, where the success information indicates that the terminal has successfully accessed the target cell.

It should be noted that in the embodiments of the present disclosure, the steps performed by the terminal can form a new embodiment separately, and the steps performed by the network device can also form a new embodiment separately, which is not limited in the embodiments of the present disclosure.

It should be noted that this embodiment can be divided into new embodiments, or combined with other embodiments to form a new embodiment. The present disclosure does not limit the combination between embodiments.

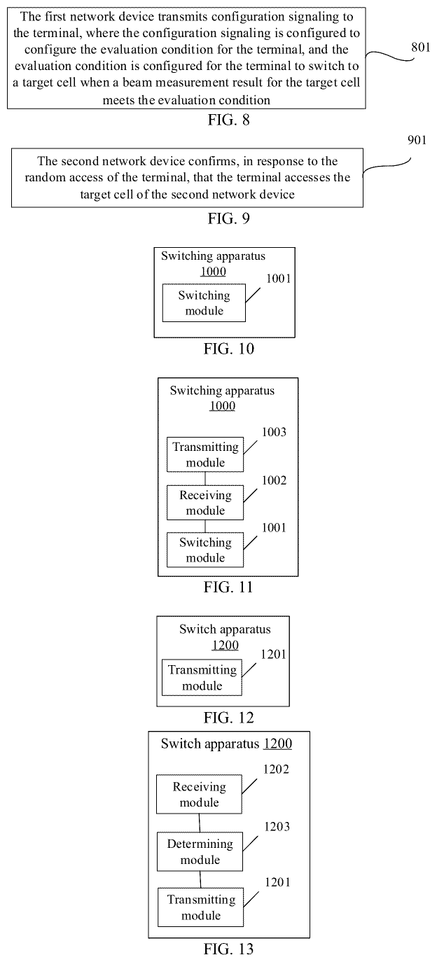

FIG. 8 is a flowchart of a switching method according to an embodiment of the present disclosure, which can be applied to the first network device shown in FIG. 1. The method includes at least some of the following contents.

In step 801, the first network device transmits configuration signaling to the terminal, where the configuration signaling is configured to configure the evaluation condition for the terminal, and the evaluation condition is configured for the terminal to switch to a target cell when a beam measurement result for the target cell meets the evaluation condition.

In some embodiments, the first network device corresponds to the source cell and can also be the source cell.

The beam measurement result refers to the result obtained by the terminal through L1 (layer 1) measurement. The evaluation condition refers to a judgment condition for performing cell handover for the terminal. When the terminal determines that the beam measurement result for a candidate cell meets the evaluation condition, the terminal can switch to the candidate cell that meets the evaluation condition.

In the embodiments of the present disclosure, the beam measurement result includes the measurement result obtained by the terminal performing measurement on at least one candidate cell. That is, the terminal measures at least one candidate cell, to obtain the beam measurement result for the at least one candidate cell. Subsequently, the terminal can determine whether to switch to the target cell based on the beam measurement result.

The candidate cell refers to a cell that the terminal can perform beam measurement on and may be accessed by the terminal as the target cell. In some embodiments, at least one candidate cell is configured by a network device.

In some embodiments, the configuration signaling includes an event identification, where the event identification indicates the event corresponding to the evaluation condition.

In the embodiments of the present disclosure, the first network device configures an event corresponding to the evaluation condition for the terminal through configuration signaling, and the terminal determines whether the candidate cell meets the evaluation condition based on whether the event occurs.

For example, event identification 1 indicates event 1, and event identification 2 indicates event 2. Alternatively, event identification can be other identification to indicate other events, which is not limited in the embodiments of the present disclosure.

In some embodiments, the event configured by the configuration signaling is an LI event, and the first network device can configure the evaluation condition for the terminal through the configuration signaling.

In some embodiments, the LI event includes at least one of the following.
(1) Event 1, where Event 1 is the measurement result of the best beam for a candidate cell being greater than the sum of the measurement result of the best beam of the serving cell and the first offset value (offset 1).
(2) Event 2, where Event 2 is the average value of the beam measurement result for a candidate cell being greater than the sum of the average value of the beam measurement result for the serving cell and the second offset value (offset 2).
(3) Event 3, where Event 3 is the average or maximum value of the beam measurement result for the candidate cell being greater than the preset threshold.
(4) Event 4, where Event 4 is the top N best measurement results being the measurement results for candidate cells, where N is a positive integer.

It should be noted that the embodiments of the present disclosure are illustrated using the four events as examples, and the embodiments of the present disclosure may also include other events, which is not limited by the embodiments of the present disclosure.

In some embodiments, the configuration signaling is RRC signaling or other types of signaling, which is not limited by the embodiments of the present disclosure.

In some embodiments, the target cell is a cell meeting the evaluation condition that is determined by the terminal based on the beam measurement result for the at least one candidate cell.

In some embodiments, the target cell is a cell that meets the evaluation condition. When there is a candidate cell whose beam measurement result meets the evaluation condition in the at least one candidate cell, the candidate cell that meets the evaluation condition is determined as the target cell.

In some embodiments, the target cell is determined from a plurality of candidate cells that meet the evaluation condition. When there are a plurality of candidate cells, if beam measurement results for multiple candidate cells in the plurality of candidate cells meet the evaluation condition, one candidate cell is selected from the multiple candidate cells that meet the evaluation condition as the target cell.

In the embodiments provided in the present disclosure, a scheme is provided for a terminal to determine whether to perform cell switching based on the beam measurement result, ensuring that the terminal performs cell switching when the beam measurement result meets the evaluation condition, which breaks the limitation of requiring the network device to control the terminal for switching, and allows the terminal to determine cell switching on its own, reducing the required switching time and improving the timeliness of switching.

It should be noted that there are various ways for the first network device to configure the evaluation condition for the terminal in the present disclosure. The evaluation condition configured by the first network device will be explained below.

The first method: the first network device configures the evaluation condition for the terminal based on the beam measurement result. The first network device receives the beam measurement result for the at least one candidate cell transmitted by the terminal, and determines the configuration signaling based on the beam measurement result for the at least one candidate cell.

In the embodiments of the present disclosure, the terminal performs beam measurement on the at least one candidate cell to obtain the beam measurement result, and then transmits the measured beam measurement result to the first network device. After receiving the beam measurement result for the at least one candidate cell, the first network device can determine the configuration signaling based on the received beam measurement result, and then configure the evaluation condition for the terminal. Subsequently, the terminal can determine whether the at least one candidate cell meets the evaluation condition based on the configured evaluation condition.

In some embodiments, at least one candidate cell is configured by the first network device, or configured in other ways, which is not limited in the embodiments of the present disclosure.

In the solution provided by the embodiments of the present disclosure, the first network device can determine the configuration signaling based on the beam measurement result for the at least one candidate cell, and then configure the evaluation conditions for the terminal, such that the terminal can perform cell switching based on the configured evaluation condition, which breaks the limitation of requiring the network device to control the terminal for switching. The terminal can determine the cell switching itself, which reduces the required switching time and improves the timeliness of switching.

The second method: the first network device configures the evaluation condition for the terminal based on the measurement results of neighbor cells.

In the embodiments of the present disclosure, the first network device receives the cell measurement result for at least one neighbor cell transmitted by the terminal, and determines the configuration signaling based on the cell measurement result for at least one neighbor cell.

In the embodiments of the present disclosure, the terminal performs cell measurement on at least one neighbor cell to obtain the cell measurement result, and then transmits the measured cell measurement result to the first network device. After receiving the cell measurement result for at least one neighbor cell, the first network device can determine the configuration signaling based on the received cell measurement result, and then configure the evaluation condition for the terminal. Subsequently, the terminal can determine whether at least one candidate cell meets the evaluation conditions based on the configured evaluation condition.

In some embodiments, at least one neighbor cell is configured by the first network device, or configured in other ways, which is not limited in the embodiments of the present disclosure.

In the solution provided by the embodiments of the present disclosure, the first network device can determine the configuration signaling based on the beam measurement result for the at least one neighbor cell, and then configure the evaluation conditions for the terminal, such that the terminal can perform cell switching based on the configured evaluation condition, which breaks the limitation of requiring the network device to control the terminal for switching. The terminal can determine the cell switching itself, which reduces the required switching time and improves the timeliness of switching.

In some embodiments, the configuration signaling is further configured to configure at least one candidate cell for the terminal, where the at least one candidate cell is a cell for determining whether the evaluation condition is met, and the at least one candidate cell is determined by the first network device based on the cell measurement result for the at least one neighbor cell.

Where at least one candidate cell is determined by the first network device based on the cell measurement result for at least one neighbor cell. That is, when it is determined that the cell measurement result for the neighbor cell meets the configuration condition, the neighbor cell corresponding to the cell measurement result that meet the configuration condition can be determined as the candidate cell.

In some embodiments, in the case where the cell measurement result for a neighbor cell is greater than the preset measurement result, it is determined that the cell measurement result for the neighbor cell meets the configuration condition.

It should be noted that after receiving the configuration signaling, the terminal can determine at least one candidate cell configured by the configuration signaling. The terminal can then perform beam measurement on the at least one candidate cell indicated by the configuration signaling, determine whether the evaluation condition is met based on the obtained beam measurement result, and ultimately switch to the target cell that meets the evaluation condition.

In some embodiments, after receiving the configuration signaling transmitted by the first network device, the terminal will not perform beam measurement on all candidate cells configured by the configuration signaling, but can perform beam measurements on some of the candidate cells configured by the configuration signaling, and then determine whether the evaluation condition is met based on the beam measurement results of some of the candidate cells.

Where the terminal receives indication signaling transmitted by the first network device. The indication signaling indicates at least one to-be-evaluated cell. At least one to-be-evaluated cell belongs to at least one candidate cell, and the number of to-be-evaluated cells is less than the number of candidate cells. The at least one to-be-evaluated cell is a cell for which the terminal currently determines whether the evaluation condition is met.

In the embodiments of the present disclosure, the first network device transmits indication signaling to the terminal, and through the indication signaling, some of the at least one of the candidate cells can be activated, and the activated cells are the to-be-evaluated cells. Alternatively, some of the at least one candidate cell can be activated through the indication signaling, and the cells other than the activated cells in the at least one candidate cell are the to-be-evaluated cells. Alternatively, by the indication signaling, some of the at least one candidate cell can be selected, and the selected cells are the to-be-evaluated cells.

In the embodiments of the present disclosure, at least one to-be-evaluated cell is indicated through the indication signaling, and the terminal can perform beam measurement on the at least one to-be-evaluated cell to obtain the beam measurement result without measuring all candidate cells, which can save terminal energy consumption.

FIG. 9 is a flowchart of a switching method according to an embodiment of the present disclosure, which can be applied to the second network device shown in FIG. 1. The method includes at least some of the following contents.

In step 901, the second network device confirms, in response to the random access of the terminal, that the terminal accesses the target cell of the second network device.

In the embodiments of the present disclosure, the terminal will access the target cell of the second network device based on random access. After determining that the terminal has accessed through the random access, the second network device can confirm that the terminal has accessed the target cell of the second network device.

It should be noted that the embodiment of the present disclosure is illustrated using the example of the second network device responding to a random access to confirm that the terminal accesses the target cell. In another embodiment, the second network device receives the access confirmation information transmitted by the terminal and confirms that the terminal accesses the target cell.

FIG. 10 is a block diagram of a switching apparatus 1000 according to an embodiment of the present disclosure. Referring to FIG. 10, the apparatus includes a switching module 1001.

The switching module 1001, configured to, in response to determining that a beam measurement result for a target cell meets an evaluation condition, switch to the target cell.

In some embodiments, referring to FIG. 11, the apparatus 1000 further includes a receiving module 1002 and a transmitting module 1003.

The receiving module 1002, configured to receive configuration signaling transmitted by a first network device, where the configuration signaling is configured to configure the evaluation condition for the terminal.

In some embodiments, the configuration signaling includes an event identification, where the event identification indicates the event corresponding to the evaluation condition.

The transmitting module 1003, configured to transmit a beam measurement result for at least one candidate cell to the first network device.

The configuration signaling is determined by the first network device based on the beam measurement result for the at least one candidate cell and transmitted by the first network device.

The transmitting module 1003 may be configured to transmit the cell measurement result for at least one neighbor cell to the first network device.

Where the configuration signaling is determined by the first network device based on the cell measurement result for the at least one neighbor cell and transmitted by the first network device.

In some embodiments, the configuration signaling is further configured to configure at least one candidate cell for the terminal, where the at least one candidate cell is a cell for determining whether the evaluation condition is met, and the at least one candidate cell is determined by the first network device based on the cell measurement result for the at least one neighbor cell.

The receiving module 1002 may be configured to receive indication signaling transmitted by the first network device. The indication signaling indicates at least one to-be-evaluated cell. At least one to-be-evaluated cell belongs to at least one candidate cell, and the number of to-be-evaluated cells is less than the number of candidate cells. The at least one to-be-evaluated cell is a cell for which the terminal currently determines whether the evaluation condition is met.

In some embodiments, the target cell is a cell that meets the evaluation condition.

In some embodiments, the target cell is determined from a plurality of candidate cells that meet the evaluation condition.

In some embodiments, the switching module 1001 is further configured to access the target cell through random access.

In some embodiments, the switching module 1001 is further configured to, when TA has been obtained, transmit access confirmation information to the second network device corresponding to the target cell based on the configured resources and switch to the target cell.

In some embodiments, the configuration signaling is RRC signaling.

It should be noted that when the apparatus 1000 provided in the embodiments implements the function, the apparatus is divided into functional modules as an example for illustration. In practical applications, these functions can be completed by different functional modules according to needs, that is, the internal structure of a device is divided into different functional modules, so as to complete all or part of these functions. In addition, the embodiments for the apparatus 1000 and the embodiments for the method provided by the present disclosure belong to the same concept, and the specific implementation process is detailed in the method embodiments, which will not be repeated here.

FIG. 12 is a block diagram of a switching apparatus 1200 according to an embodiment of the present disclosure. Referring to FIG. 12, the apparatus includes a transmitting module 1201.

The transmitting module 1201 is configured to transmit configuration signaling to a terminal, where the configuration signaling is configured to configure an evaluation condition for the terminal. Where the evaluation condition is configured for the terminal to switch to a target cell when a beam measurement result for the target cell meets the evaluation condition.

In some embodiments, the configuration signaling includes an event identification, where the event identification indicates the event corresponding to the evaluation condition.

In some embodiments, referring to FIG. 13, the apparatus 1200 further includes a receiving module 1202 and a determining module 1203.

The receiving module 1202, configured to receive the beam measurement result for at least one candidate cell transmitted by the terminal.

The determining module 1203, configured to determine the configuration signaling based on the beam measurement result for the at least one candidate cell.

In some embodiments, the modules of the apparatus 1200 further includes the following.

The receiving module 1202 may be configured to receive the cell measurement result for at least one neighbor cell transmitted by the terminal.

The determining module 1203 may be configured to determine the configuration signaling based on the cell measurement result for at least one neighbor cell.

In some embodiments, the configuration signaling is further configured to configure at least one candidate cell for the terminal, where the at least one candidate cell is a cell for determining whether the evaluation condition is met, and the at least one candidate cell is determined by the first network device based on the cell measurement result for the at least one neighbor cell.

In some embodiments, the transmitting module 1201 is configured to transmit indication signaling to the terminal. The indication signaling indicates at least one to-be-evaluated cell. At least one to-be-evaluated cell belongs to at least one candidate cell, and the number of to-be-evaluated cells is less than the number of candidate cells. The at least one to-be-evaluated cell is a cell for which the terminal currently determines whether the evaluation condition is met.

In some embodiments, the configuration signaling is RRC signaling.

It should be noted that when the apparatus 1200 provided in the embodiments implements the function, the apparatus 1200 is divided into functional modules as an example for illustration. In practical applications, these functions can be completed by different functional modules according to needs, that is, the internal structure of a device is divided into different functional modules, so as to complete all or part of these functions. In addition, the embodiments for the apparatus and the embodiments for the method provided by the present disclosure belong to the same concept, and the specific implementation process is detailed in the method embodiments, which will not be repeated here.

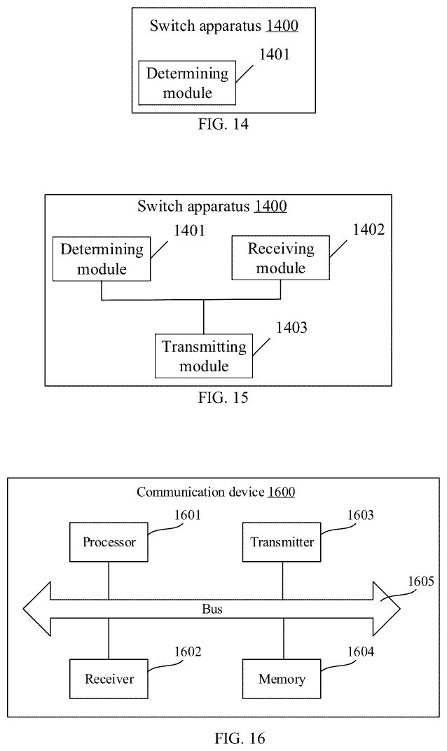

FIG. 14 is a block diagram of a switching apparatus 1400 according to an embodiment of the present disclosure. Referring to FIG. 14, the apparatus 1400 includes a determining module 1401.

The determining module 1401 is configured to, in response to a random access of a terminal, confirm that the terminal accesses a target cell corresponding to the second network device.

In some embodiments, referring to FIG. 15, the apparatus 1400 further includes a receiving module 1402 and a transmitting module 1403.

The receiving module 1402 is configured to receive access confirmation information transmitted by the terminal, and confirm that the terminal accesses the target cell, where the access confirmation information is transmitted by the terminal based on configured resources after TA is obtained.

The transmitting module 1403 is configured to transmit success information to a central unit (CU), where the success information indicates that the terminal successfully accesses the target cell.

FIG. 16 is a structural schematic diagram of a communication device 1600 provided in an embodiment of the present disclosure. The communication device 1600 includes a processor 1601, a receiver 1602, a transmitter 1603, a memory 1604, and a bus 1605.

The processor 1601 includes one or more processing cores, the processor 1601 executes various functional applications and information processing by running software programs and modules.

The receiver 1602 and the transmitter 1603 can be implemented as a communication component, and the communication component can be a communication chip.

The memory 1604 is connected to the processor 1601 through the bus 1605.

The memory 1604 can be used to store at least one program code, and the processor 1601 is used to execute the at least one program code to implement the various steps in the method embodiments.

In addition, the communication device can be a terminal or a network device. The memory 1604 can be implemented by any type of volatile or non-volatile storage device or combination thereof, including but not limited to: magnetic or optical disks, electrically erasable programmable read only memory (EEPROM), erasable programmable read only memory (EPROM), static random access memory (SRAM), read only memory (ROM), magnetic storage, flash memory, or programmable read only memory (PROM).

In some embodiments, a non-transitory computer-readable storage medium is further provided, which stores executable program code loaded and executed by a processor to implement the switching method executed by a communication device according to each of the embodiments described.

In an embodiment, a chip is provided including programmable logic circuits and/or program instructions for implementing the switching method according to each of the embodiments when the chip is run on a terminal or a network device.

In an embodiment, a computer program product is provided that, when executed by a processor of a terminal or network device, is configured to implement the switching method according to each of the embodiments described.

Those skilled in the field can understand that all or part of the steps to implement the embodiments can be completed through hardware, or through programs that instruct relevant hardware to complete. The program can be stored in a computer-readable storage medium, such as read-only memory, magnetic disk, or optical disk.

The embodiments provided in the present disclosure are not intended to limit the present disclosure. Any modifications, equivalent replacements, improvements, etc. made within the spirit and principles of the present disclosure shall be included in the scope of protection of the present disclosure.

1. A switching method, performed by a terminal, comprising:
in response to determining that a beam measurement result for a target cell meets an evaluation condition, switching to the target cell.

2. The method according to claim 1, further comprising:
receiving configuration signaling transmitted by a first network device, wherein the configuration signaling is configured to configure the evaluation condition for the terminal, and the configuration signaling comprises a Radio Resource Control (RRC) signaling.

3. The method according to claim 2,
wherein the configuration signaling comprises an event identification, and
wherein the event identification indicates an event corresponding to the evaluation condition.

4. The method according to claim 2, further comprising:
transmitting a beam measurement result for at least one candidate cell to the first network device;, and
wherein the configuration signaling is determined by the first network device based on the beam measurement result for the at least one candidate cell and transmitted by the first network device.

5. The method according to claim 2, further comprising:
transmitting a cell measurement result for at least one neighbor cell to the first network device, and
wherein the configuration signaling is determined by the first network device based on the cell measurement result for the at least one neighbor cell and transmitted by the first network device.

6. The method according to claim 5, wherein
the configuration signaling is further configured to configure at least one candidate cell for the terminal,
the at least one candidate cell is a cell for determining whether the evaluation condition is met, and
the at least one candidate cell is determined by the first network device based on the cell measurement result for the at least one neighbor cell.

7. The method according to claim 6, further comprising:
receiving indication signaling transmitted by the first network device, wherein
the indication signaling indicates at least one to-be-evaluated cell,
the at least one to-be-evaluated cell belongs to the at least one candidate cell,
a number of the at least one to-be-evaluated cell is less than a number of the at least one candidate cell, and
the at least one to-be-evaluated cell is a cell for which the terminal currently determines whether the evaluation condition is met.

8. The method according to claim 1, wherein the target cell meets the evaluation condition; or the target cell is determined from a plurality of candidate cells that meet the evaluation condition.

9. (canceled)

10. The method according to claim 1, wherein switching to the target cell comprises:
accessing the target cell through random access; or
in response to timing advance (TA) having been obtained, transmitting, based on a configured resource, access confirmation information to a second network device corresponding to the target cell, to switch to the target cell.

11-12. (canceled)

13. A switching method, performed by a first network device, comprising:
transmitting configuration signaling to a terminal, wherein the configuration signaling is configured to configure an evaluation condition for the terminal, and
wherein the evaluation condition is configured for the terminal to switch to a target cell when a beam measurement result for the target cell meets the evaluation condition.

14. The method according to claim 13, wherein
the configuration signaling comprises an event identification,
the event identification indicates an event corresponding to the evaluation condition, and
the configuration signaling comprises a Radio Resource Control (RRC) signaling.

15. The method according to claim 13, further comprising:
receiving a beam measurement result for at least one candidate cell transmitted by the terminal; and
determining the configuration signaling based on the beam measurement result for the at least one candidate cell.

16. The method according to claim 13, further comprising:
receiving a cell measurement result for at least one neighbor cell transmitted by the terminal; and
determining the configuration signaling based on the cell measurement result for the at least one neighbor cell.

17. The method according to claim 16, wherein
the configuration signaling is further configured to configure at least one candidate cell for the terminal,
the at least one candidate cell is a cell for determining whether the evaluation condition is met, and
the at least one candidate cell is determined by the first network device based on the cell measurement result for the at least one neighbor cell.

18. The method according to claim 17, further comprising:
transmitting indication signaling to the terminal, wherein
the indication signaling indicates at least one to-be-evaluated cell,
the at least one to-be-evaluated cell belongs to the at least one candidate cell,
a number of the at least one to-be-evaluated cell is less than a number of the at least one candidate cell, and
the at least one to-be-evaluated cell is a cell for which the terminal currently determines whether the evaluation condition is met.

19. (canceled)

20. A switching method, performed by a second network device, comprising:
in response to a random access of a terminal, confirming that the terminal accesses a target cell corresponding to the second network device; or
in response to receiving access confirmation information transmitted by the terminal, confirming that the terminal accesses the target cell, wherein the access confirmation information is transmitted by the terminal based on configured resources after TA is obtained.

21. (canceled)

22. The method according to claim 20, further comprising:
transmitting success information to a central unit (CU), wherein the success information indicates that the terminal successfully accesses the target cell.

23-25. (canceled)

26. A terminal, comprising:
one or more processors; and
a transceiver connected to the one or more processors, and
wherein the one or more processors are configured to load and execute executable instructions to implement the switching method according to claim 1.

27. A network device comprising:
one or more processors; and
a transceiver connected to the one or more processors, and
wherein the one or more processors are configured to load and execute executable instructions to implement the switching method according to claim 13.

28. A non-transitory computer-readable storage medium storing an executable program code, wherein the executable program code is loaded and executed by one or more processors to implement the switching method according to claim 1.
